(19) United States
(12) Patent Application Publication
(10) Pub. No.: US 2007/0069656 A1
(43) Pub. Date: Mar. 29, 2007

(54) Multifunctional light

(76) Inventor: Tsung-Jung Huang, Taipei city (TW)

Correspondence Address: TROXELL LAW OFFICE PLLC, SUITE 1404, 5205 LEESBURG PIKE, FALLS CHURCH, VA, 22041, US

(21) Appl. No.: 11/523,517

(22) Filed: Sep. 20, 2006

(30) Foreign Application Priority Data
Sep. 26, 2005 (CN) 200520127909.X

(51) Int. Cl. H05B 37/00

(52) U.S. Cl. 315/86

(57) ABSTRACT

A multifunctional light which uninterruptedly has illuminating function in both the cases that the civil power is supplied and the civil power is cut off. The multifunctional light includes a lamp, a civil power circuit for providing civil power, a spare circuit for providing spare power, a controller bridged between the lamp, the civil power circuit and the spare circuit and a current stabilizer. According to the control of a user and whether the civil power is supplied, the controller selectively connects the lamp with the civil power circuit or the spare circuit. The controller can be electrically connected to a detection system to also have an emergency detection function.

### BACKGROUND OF THE INVENTION

The present invention is related to a multifunctional light which uninterruptedly has illuminating function in both the cases that the civil power is supplied and the civil power is cut off. The multifunctional light also has emergency detection function.

An emergency light serves to uninterruptedly continuously provide illuminating effect in the case that the normal power (civil power) is cut off. The emergency light provides basic illumination for a house, a working site or an escape passage, whereby people can temporarily emergently handle the situation and be guided to escape from the escape passage. The escape guiding equipments include exit indicator lamp positioned above the safety door and the direction indicator lamp arranged in the corner. In the case that the normal power is cut off, people can still tell the escape direction and the position of the safety door so as to ensure safety.

Most of the typical emergency lights are wall emergency lights. The emergency lights are mounted on the walls of the hallway, the staircase, passage, etc. In general, the emergency light is equipped with an AC/DC automatic switch. At normal time, the spare battery is automatically charged by AC power. When saturated, the AC power will automatically stop charging the battery. In the case that the power is cut off, the emergency light is switched to the spare battery for supplying power as emergent illumination.

The emergency light is independent from the original illuminator of a site. A consumer often purchases emergency lights and installs the emergency lights in a building. However, the emergency lights are mounted on the walls of the hallway, the staircase, passage, etc. In the case that the civil power is cut off, the emergency lights can only project light from the walls. The illuminated area is quite limited.

An indoor illuminator in a house or a working site, such as a fluorescent lamp, is turned on or off by means of a switch. The common fluorescent lamp is powered on by civil power supply. In contrast to the common fluorescent lamp, the conventional emergency light provides illuminating effect only when the power is cut off. It is tried by the applicant to provide an indoor emergency light which can still provide illuminating function in the case that the civil power is cut off. Accordingly, the indoor light not only serves to provide illuminating effect at normal time, but also serves as an emergency light for providing illuminating function in an emergency. Taiwanese Patent Publication No. 581198 entitled “fluorescent lamp with emergency illumination function” of this applicant discloses a fluorescent lamp with both normal illumination function and emergency illumination function.

Moreover, the present invention is applicable to other emergency equipment. In case that the normal power is cut off, the emergency equipment can be still powered on to keep the detection or alarm function.

### SUMMARY OF THE INVENTION

It is therefore a primary object of the present invention to provide a multifunctional light which uninterruptedly has illuminating function in both the cases that the civil power is supplied and the civil power is cut off.

It is a further object of the present invention to provide the above multifunctional light which can be electrically connected to a detection system to also have an emergency detection function.

According to the above objects, the multifunctional light of the present invention includes a lamp, a controlling circuit and a spare circuit electrically connected to the controlling circuit and the lamp. A current stabilizer is disposed between the controller and the lamp for stabilizing the supply of the civil power and spare power.

Under control of the controller, the lamp can be uninterruptedly selectively powered on by the civil power circuit or the spare circuit. The controller can be electrically connected to a detection system to also have an emergency detection function. In case of abnormal heat or smoke, a sensor of the detection system will transmit an electric signal to activate an emergency alarm.

The present invention can be best understood through the following description and accompanying drawings wherein:

### BRIEF DESCRIPTION OF THE DRAWINGS

FIG. 1 is a flow chart of a first embodiment of the indoor light with emergency illumination function of the present invention;

FIG. 2 is a block diagram of the first embodiment of the present invention;

FIG. 3 is a block diagram of a second embodiment of the present invention, which also has an emergency detection system;

FIG. 4 is a perspective view of a third embodiment of the present invention; and

FIG. 5 is a perspective view of a fourth embodiment of the present invention.

### DETAILED DESCRIPTION OF THE PREFERRED EMBODIMENTS

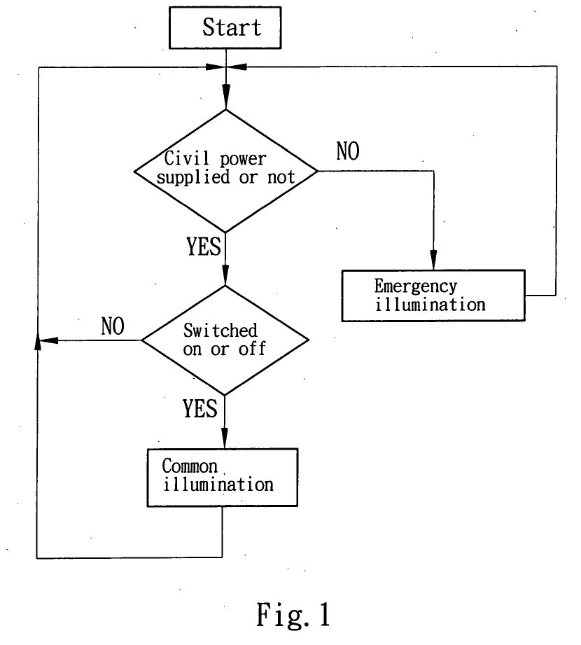

A common indoor light is turned on/off by means of a switch. In the case the civil power is cut off, it is impossible for a user to control the indoor light via the switch. In case that the civil power is cut off, the present invention is able to automatically switch the indoor light to be powered on by a spare power supply. Referring to FIG. 1, in case that the civil power is cut off, the present invention is able to automatically switch an indoor light to be powered on by a spare power supply for emergency illumination. Reversely, when the civil power is normally supplied, a user can control the indoor light via a switch. When the civil power is cut off, no matter whether the switch is switched on or off, the indoor light is automatically switched to an emergency light mode.

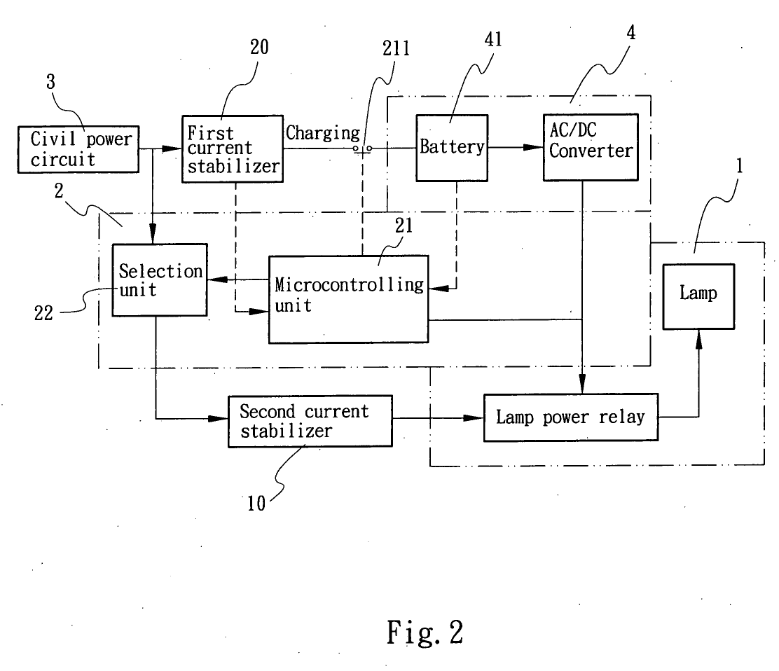

Referring to FIG. 2, the multifunctional light of the present invention includes a lamp 1, a first current stabilizer 20, a second current stabilizer 10, a controller 2, a civil power circuit 3 and a spare circuit 4. The lamp 1 is controllable by the controller 2 to be selectively powered on the civil power circuit 3 or the spare circuit 4.

The lamp 1 can be a common fluorescent lamp tube. The civil power circuit 3 serves to convert and process the civil power into the power suitable for driving the lamp 1. The input civil power is converted into DC output. The DC power is further converted into high-frequency signals fed into the lamp 1 to drive the lamp 1 for illumination. The spare circuit 4 includes a battery 41. The DC power output from the battery is processed by an AC/DC converter 42 and input to the lamp 1, whereby the lamp 1 is driven for emergency illumination. The battery of this embodiment can be a rechargeable battery electrically connected to the AC-to-DC circuit of the civil power circuit 3. When the battery does not supply power, the battery is charged by civil power. The lamp 1, civil power circuit 2 and the spare circuit 4 pertain to prior art and thus will not be further described hereinafter.

The controller 2 serves to control turning on/off of the lamp 1 when the civil power is normally supplied. In the case that the civil power is cut off, the spare power turns to power on the lamp 1. Accordingly, the lamp 1 can be switched between the civil power circuit 3 and the spare circuit 4 or connected with neither. The controller 2 includes a microcontrolling unit 21 and a selection unit 22. The microcontrolling unit 21 outputs a controlling signal to the selection unit 22 in accordance with the control of a user to the lamp 1. Accordingly, the selection unit 22 can determine whether the lamp 1 should be turned on or off in accordance with the controlling signal and whether the civil power is supplied.

When a user controls and turns on or off the lamp 1, the microcontrolling unit 21 outputs controlling signals with different potentials to the selection unit 22 to inform the selection unit 22 of the control of the user. For example, when the user turns on the lamp 1, the microcontrolling unit 21 outputs a high potential controlling signal, while when the user turns off the lamp 1, the microcontrolling unit 21 outputs a low potential controlling signal. In this embodiment, the microcontrolling unit 21 is connected with a switch 211 for a user to control and turn on/off the lamp 1. When the civil power is normally supplied, the user can turn on/off the lamp 1 via the switch 211. In this embodiment, the switch 211 is an always-on switch, that is, the switch 211 is closed at normal time. Only when the switch 211 is pressed, the circuit is opened. Accordingly, in case that the controlling signal is originally at high potential, the signal of the input end is at low potential. In case that the switch 211 is pressed or shifted, the signal of the input end will be transmitted to the output end and output. Identically, when a user again presses the switch 211, the output will be changed again. Therefore, a user can repeatedly press or shift the switch 211 to sequentially output signals with different potentials to the selection unit 22. It should be noted that other types of switches such as rotary switch, shift switch, etc. can be also used as the switch 211. The switch 211 only needs to output controlling signals with different potentials when a user turns on/off the lamp 1.

Furthermore, to facilitate description, it is assumed that when the controlling signal is at high potential, it means that a user attempt to turn off the lamp 1.

The selection unit 22 determines whether the lamp 1 should be connected to the civil power circuit 3 or the spare circuit 4 -or connected to neither according to whether the civil power is supplied and the controlling signals. Accordingly, the lamp 1 can be switched between the modes as shown in FIG. 1. To speak more detailedly, when the civil power is cut off, via the selection unit 22, the lamp 1 is connected to the spare circuit 4 and powered on by the spare power supply. When the civil power is normally supplied and a user turns on the lamp 1, via the selection unit 22, the lamp 1 is connected to the civil power circuit 3 and powered on by the civil power. Reversely, in case of normal supply of the civil power and the user turns off the lamp 1, via the selection unit 22, the lamp 1 is connected to neither the civil power circuit 3 nor the spare circuit 4. Accordingly, the lamp 1 will be extinguished.

The selection unit 22 can be composed of one or several relays. The output ends of the relays are respectively connected to two input ends of the lamp 1. The input ends of the relays are respectively electrically connected to the output ends of the spare circuit 4 and the civil power circuit 3. When the civil power is normally supplied, the selection end of the selection unit 22 is connected to the civil power circuit 3. In case the civil power is not normally supplied, the lamp 1 is connected to the spare circuit 4 and powered on by the battery.

The second current stabilizer 10 is installed between the lamp 1 and the controller 2 to provide a high voltage when the lamp 1 is turned on and limit the discharging current to a stable value. The second current stabilizer 10 serves to stabilize the power supply when the lamp 1 emits light. In addition, the first current stabilizer 20 is installed between the civil power circuit 3 and the controller 2 to enhance the stability of power supply.

The switching of the lamp 1 is further described hereinafter. First, when the civil power is normally supplied and a user presses the switch 211 to turn on the lamp 1, the microcontrolling unit 21 outputs a controlling signal of high potential. Accordingly, via the selection unit 22, the lamp 1 is connected to the civil power circuit 3 for illumination. At this time, in the case that the user again presses the switch 211 to turn off the lamp 1, the controlling signal output by the microcontrolling unit 21 becomes a signal of low potential. Accordingly, the output end of the selection unit 22 is switched to disconnect the lamp 1 from the civil power circuit 3. At this time, the lamp 1 is turned off. Therefore, in the case that the civil power is normally supplied, a user can use the switch 211 to turn on or off the lamp 1. In case the civil power is cut off, the selection unit 22 will automatically switch the output end to connect with the spare circuit 4. Accordingly, via the selection unit 22, the lamp 1 can be connected to the spare circuit 4 and powered on by the spare circuit 4 for emergency illumination.

According to the above arrangement, when the civil power is normally supplied, the indoor light can be controlled by a user to serve as a common illuminator. However, in case the civil power is cut off, via the selection unit 22, the indoor light can be powered on by the spare circuit 4 to serve as an emergency light. A user is no more necessary to additionally purchase any emergency illuminating equipment. Therefore, the cost can be saved. Moreover, the illumination range of the indoor light is wider so that the indoor light as an emergency light can illuminate larger range in case of emergency in comparison with the conventional emergency illuminator.

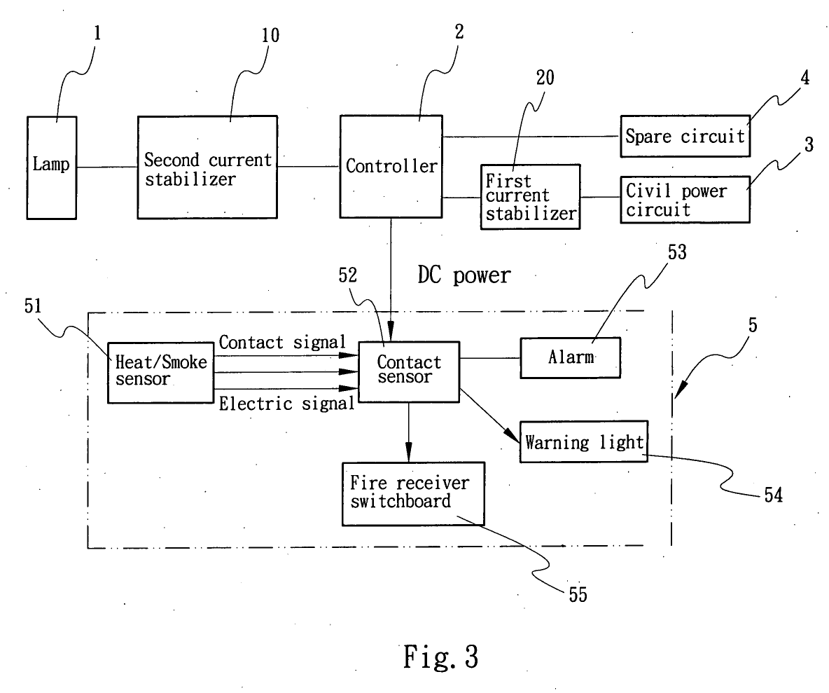

Referring to FIG. 3, an emergency detection system 5 can be added to the present invention. To speak shortly, the emergency illuminating system of the present invention is able to provide DC power in any condition so that the detection system 5 can continuously work in any condition.

An emergency detection system 5 can be bridged over the controller 2 of the emergency illumination system. The detection system 5 includes a heat/smoke sensor 51 and a contact sensor 52. In the case that the heat/smoke sensor 51 and the contact sensor 52 can be supplied with DC power in any condition, when the heat/smoke sensor 51 detects abnormal heat or smoke, the contact sensor 52 can transmit an electric signal to automatically activate an alarm 53, a warning light 54 and a fire receiver switchboard 55. It should be noted that the heat/smoke sensor 51 of the detection system 5 is an embodiment of the sensor of the present invention.

The alarm 53, warning light 54 and fire receiver switchboard 55 cooperate with each other in an emergency. Substantially, when the contact sensor 52 works in an emergency, the alarm 53 will emit an alarm sound and the warning light will emit a warning light or the fire receiver switchboard 55 will perform actual emergency procedure. Accordingly, by means of the original uninterrupted system (emergency illumination system), the present invention can provide additional heat/smoke detection function and alarm function.

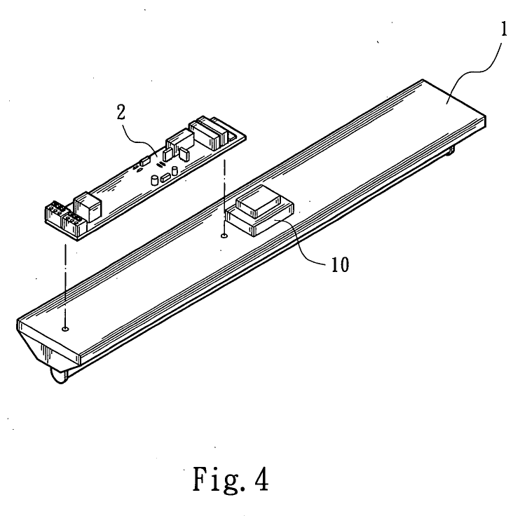

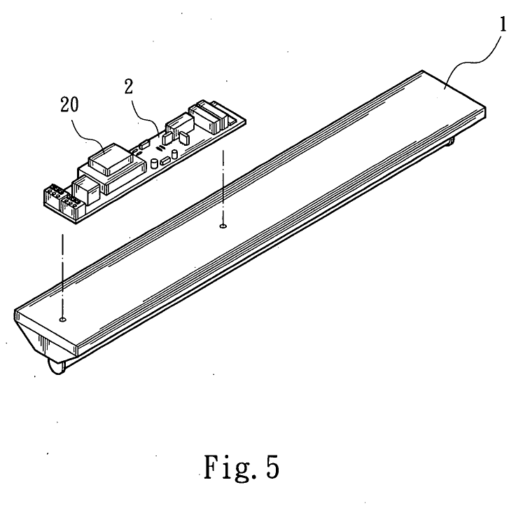

The controller 2 and the spare circuit 4 can be integrated into a controlling unit which can be co-used with a lamp 1 with the second current stabilizer 10 (as shown in FIG. 4). Alternatively, the first current stabilizer 20 can be disposed in the controller 2 (as own in FIG. 5) and then combined with the civil power circuit and the spare circuit 4 into an integrated unit. The integrated it can be co-used with the lamp 1.

The above embodiments are only used to illustrate the present invention, not intended to limit the scope thereof. Many modifications of the above embodiments can be made without departing from the spirit of the present invention.

What is claimed is:

1. A multifunctional light comprising:
a lamp;
a civil power circuit for processing civil power into a power suitable for driving the lamp and outputting the power;
a spare circuit including a battery for outputting a spare power to drive the lamp;
a controller bridged between the lamp, the civil power circuit and the spare circuit, the controller including a microcontrolling unit, whereby when the civil power is cut off, the controller makes the lamp connected to the spare circuit, while when the civil power is supplied, according to the control of a switch, the controller makes the lamp selectively turned on or off by the power supplied by the civil power circuit; and
a second current stabilizer mounted between the lamp and the controller for stabilizing the current supplied to the lamp.

2. The multifunctional light as claimed in claim 1, wherein the microcontrolling unit is connected with a switch, when the switch is pressed or shifted, the microcontrolling unit outputting a controlling signal of a potential different from the potential output before pressed, according to the civil power and the potential of the controlling signal, a selection unit determining whether the lamp should be connected to the spare circuit or the civil power circuit.

3. The multifunctional light as claimed in claim 2, wherein the selection unit is composed of multiple relays, the output ends of the selection unit being respectively connected to two input ends of the lamp, the input ends of the selection unit being respectively connected to the output ends of the spare circuit and the civil power circuit, whereby when the civil power is supplied, a selection end of the selection unit is connected to the output end of the civil power circuit, while when the civil power is cut off, the input end of the selection unit is connected to the output end of the spare circuit so that the battery supplies power to the lamp.

4. The multifunctional light as claimed in claim 2, wherein the switch is an always-on switch.

5. The multifunctional light as claimed in claim 2, wherein when the switch controls the microcontrolling unit to output a controlling signal of high potential, the lamp is turned on, while when the switch controls the microcontrolling unit to output a controlling signal of low potential, the lamp is turned off.

6. The multifunctional light as claimed in claim 1, wherein a first current stabilizer is disposed between the civil power circuit and the controller.

7. The multifunctional light as claimed in claim 2, wherein a first current stabilizer is disposed between the civil power circuit and the controller.

8. The multifunctional light as claimed in claim 3, wherein a first current stabilizer is disposed between the civil power circuit and the controller.

9. The multifunctional light as claimed in claim 1, further comprising a detection system including:
a detection sensor, when detecting an abnormal state of the environment, the detection sensor transmitting an electric signal; and
a contact sensor powered on under control of the controller, when receiving the electric signal, the contact sensor automatically outputting an emergency signal.

10. The multifunctional light as claimed in claim 2, further comprising a detection system including:
a detection sensor, when detecting an abnormal state of the environment, the detection sensor transmitting an electric signal; and
a contact sensor powered on under control of the controller, when receiving the electric signal, the contact sensor automatically outputting an emergency signal.

11. The multifunctional light as claimed in claim 3, further comprising a detection system including:
a detection sensor, when detecting an abnormal state of the environment, the detection sensor transmitting an electric signal; and
a contact sensor powered on under control of the controller, when receiving the electric signal, the contact sensor automatically outputting an emergency signal.

12. The multifunctional light as claimed in claim 9, wherein the detection sensor is a heat/smoke sensor.

13. The multifunctional light as claimed in claim 10, wherein the detection sensor is a heat/smoke sensor.

14. The multifunctional light as claimed in claim 11, wherein the detection sensor is a heat/smoke sensor.

15. The multifunctional light as claimed in claim 9, wherein the detection system further includes an alarm, whereby when the contact sensor outputs the emergency signal, the alarm emits an alarm sound.

16. The multifunctional light as claimed in claim 10, wherein the detection system further includes a warning light, whereby when the contact sensor outputs the emergency signal, the warning light emits a warning light.

17. The multifunctional light as claimed in claim 11, wherein the detection system further includes an alarm, whereby when the contact sensor outputs the emergency signal, the alarm emits an alarm sound.

18. The multifunctional light as claimed in claim 9, wherein the detection system further includes a fire receiver switchboard, whereby when the contact sensor outputs the emergency signal, the fire receiver switchboard performs preset emergency procedure.

19. The multifunctional light as claimed in claim 10, wherein the detection system further includes a fire receiver switchboard, whereby when the contact sensor outputs the emergency signal, the fire receiver switchboard performs preset emergency procedure.

20. The multifunctional light as claimed in claim 11, wherein the detection system further includes a fire receiver switchboard, whereby when the contact sensor outputs the emergency signal, the fire receiver switchboard performs preset emergency procedure.
